(19) United States
(12) Patent Application Publication
(10) Pub. No.: US 2011/0055098 A1
(43) Pub. Date: Mar. 3, 2011

(54) Automated employment information exchange and method for employment compatibility verification

(76) Inventor: Jeffrey A. Stewart, New York, NY (US)

(21) Appl. No.: 12/387,176

(22) Filed: Apr. 29, 2009

Related U.S. Application Data
(60) Provisional application No. 61/125,920, filed on Apr. 30, 2008.

(51) Int. Cl. G06Q 10/00

(52) U.S. Cl. 705/321

(57) ABSTRACT

A computer implemented system is provided to manage the exchange of information about people seeking employment with suitable job opportunities through the use of linguistic technologies. The system is particularly useful for job hiring environments which require an exchange between companies looking to hire employees and individuals seeking employment. The system manages a database of job candidates who have been interviewed and answers have been recorded. The system converts the candidate's answers into a personal linguistic profile and then analyzes the linguistic profile to reveal the candidates unique talents and skills to find the most suitable job opportunities.

### CROSS REFERENCE TO RELATED APPLICATION

This application claims priority from U.S. Provisional Application No. 61/125,920 filed on Apr. 30, 2008, herein incorporated by reference.

### FIELD OF THE INVENTION

The present invention relates generally to the use of linguistic and statistical profiling to assess sales, business development and account management professionals, as well as other professionals that communicate verbally. More particularly, the present invention relates to the specific methods, system, and programs for building unique data sets and the applications of algorithms to these data sets for the purpose of linguistics and statistical profiling.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

Assessment has long been a favored tool of hiring managers and human resources professionals to better understand certain attributes of a team or an individual. Assessment is incorporated in the hiring process to determine if the particular attributes of a candidate are compatible with those of the open position or the team, or to uncover a particular disconnect that has not been revealed in an interview. Profile assessments, such as the Myers-Briggs or the Caliper Assessment, have been in use since the 1970's to determine if an applicant's aptitudes and strengths match the particular characteristics of a specific job, industry, or sector.

Assessment is particularly useful in the processes of filling sales position, as sales employees rely so heavily on their communications skills that they are often difficult to assess objectively. Accurate sales assessments help hiring managers and sales managers determine if the candidate's skill set is compatible with the requirements of the open position.

Accurate assessments are important to sales and hiring managers because sales positions are notoriously difficult to fill accurately and consistently. Studies revealed that most companies are only 52% successful at screening out professionals that are a poor fit for the position. This is due largely to the fact that mediocre sales candidates can interview just as well as elite sales candidates. This 48% failure rate, combined with a general inability to fully staff sales positions represents one of the largest needs for improvement in industry today. Sales assessments are generally used to determine whether the particular skills and aptitudes of a candidate match those of the open position, thus determining whether or not the candidate is likely to succeed. Sales assessments can also be effective at determining whether or not a candidate will be a good fit for the open position, the sales team, and the organization as a whole. By utilizing a sales assessment in the screening, hiring, and management processes, managers can benefit from lower turnover, better margins, and increased productivity.

Sales Assessments on the market today are generally regarded as vague or ineffective. Often, the best sales professionals can't be bothered to fill out lengthy forms or answer the hundreds of personal questions that comprise most assessments. Top sales professionals are concerned with closing new business, not filling out lengthy forms. The goal of most sales assessments is to profile the top performing professionals and use them as “models” or “benchmarks” for the entire team. However, if the top echelon is reluctant to take the assessment, an adverse selection bias develops, which inhibits the ability of sales assessments to “benchmark” top performing sales professionals. To complicate matters, there are conflicting philosophies for assessing sales professionals. While some argue that traditional personality assessments (e.g Myers-Briggs or DISC) are best, others maintain that occupation-specific assessments are more accurate (e.g, Caliper or Craft). Unfortunately, assessment practices vary wildly among companies, so no standard has yet to emerge.

New technologies have become available that allow for a new type of sales assessment that can overcome low adoption rates and provide constructive, useful feedback. The convergence of algorithmic technologies, speech and recording technologies, and faster processing power has allowed the present invention to create a new form of sales assessment that will be easier and more accurate than those currently on the market today.

Since the late 1990's there has been a rise and mass adoption of once-cutting-edge technologies in the areas of natural language processing, machine learning, and text analytics, which are subfields of computational linguistics—the study of using computers to model natural language. In the past decade, online search leaders like Google have brought these technologies into homes around the world. The terrorist attacks of Sep. 11, 2001 catalyzed this growth by creating an urgent need for the government-sponsored surveillance echo system to analyze massive amounts of unstructured voice and text communications. This focus has resulted in the rapid advancement of these technologies.

Fueled by increased processing power as well as decreased bandwidth and storage costs, computational linguistics has become increasingly popular and commercially viable. Aside from online search, less obvious applications of these technologies abound in other industries such as pharmaceutical discovery, financial intelligence, and predictive psychology.

Robust data sets are critical to the creation of text analytics algorithms. Data sets are instrumental in the analytical process because they serve as the building blocks of the algorithm's screening criterion. In recent years, there has been exponential growth in the availability of online data sets and taxonomies. Frequently updated job boards, social networks, and resume repositories provide massive amounts of valuable data suitable for computational linguistic analysis.

It would be desirable for a system, method, or program to provide for an automated matching between candidate employees and job opportunities based on a deep understanding of a company's sales organization, product, sales process and target customer. It would further be desirable for such a system to be able to profile the candidate employee, facilitate linguistic analysis to reveal the unique talents of that candidate, identify the most appropriate job opportunities for that candidate, and then facilitate introductions between the candidate employee and the hiring company. It would be still further desirable to facilitate an information exchange between the hiring company and the job candidate after the candidate accepts the job opportunity.

The present invention seeks to capitalize on these trends and revolutionize the way that sales, business development, and account management professionals are matched with companies. The present invention applies technologies of text analytics, machine learning, and pattern recognition to the process of finding and assessing sales talent. More specifically, the present invention applies such technologies to information collected from a conversation with a candidate, automatically profiling the candidate employee, facilitating linguistic analysis to reveal the unique talents of that candidate, and automatically building an assessment report.

### SUMMARY OF THE INVENTION

Despite the tremendous advantage of using text analytics and statistical pattern recognition, sales hiring decisions are still mainly conducted based on “gut instinct”. This is highly inefficient and results in an industry wide hiring success rate of only 50%. The present invention offers a solution to change that by providing companies a scientifically driven approach to finding, screening and assessing sales professionals in order to find the best matched candidates for their open positions. The invention can also be used by companies to assess members of their current sales organization, or any other position that relies heavily on verbal communication. It is the object of the present invention to apply process and technology to a function that historically was performed based on “gut instinct” or was delegated to human resource generalists with limited intimate knowledge of the selling process.

Textual transcription is a rich source of data for deep analysis that can go above and beyond the analysis of a resume. A resume contains approximately 600 data points. By contrast, a transcribed phone call contains upwards of 6,000 data points. That's 10 times more data that can be gathered on a person. By using text analytics algorithms, the present invention is able to apply the unbiased mathematics of machine learning, statistical analysis and pattern recognition to analyze these data points in order to resolve the problem of assessing sales professionals.

First, a candidate is engaged, either through the candidate's own initiative or through being identified and being requested to participate in an interview. Hereafter, candidate refers to a person who either actively got involved in the employment information exchange process and system of the present invention or a person who passively became involved such as by being referred to or sought after. The identification of such a candidate is not limited to, but can include a process involving a system using textual information from the internet, supplemented with supply chain taxonomies to identify potential candidates, and then someone operating the system of the present invention reaches out to the candidate to request a phone interview.

Once the conversation begins between the prospective candidate and the operator of the system or the facilitator of the process (hereafter referred to as “Career Matchmaker”), the conversation, such as a telephone call in this example, is recorded and transcribed with the permission of the candidate. The candidate is immediately connected with a Career Matchmaker, who guides him or her through a “blind” phone conversation (not targeted toward any specific job opening) about career goals, aspirations, preferences, and selling style. The phone conversation between Career Matchmaker and candidate is usually between 30 and 45 minutes in length and is loosely structured around a fixed number of topics. The conversation must cover each of these topics before it is considered a full profile.

Once the conversation is recorded and transcribed, text analytics, machine learning and pattern recognition can be applied to interview transcripts to analyze transcribed candidate interviews to create accurate assessments of the candidates so as to ensure better recommendations for optimally-matched career opportunities thereby better performing screening for sales talent. This transcribed phone call is digitally deconstructed by a program that employs text analytics, algorithms, unbiased mathematics of machine learning, statistical analysis, pattern recognition or a combination thereof to analyze these data points in order to resolve the problem of matching sales professionals to the role where they are most likely to succeed. The program will not only generate an output reflecting characteristics, preferences, skills, and aptitudes of candidates but also recommend employment positions in which have verified compatibility and are most suitable to the candidate's unique skills and talents.

The program can establish a minimum threshold for the compatibility between the candidate and the employment opportunity thereby reporting only those matched profiles achieving the minimum threshold.

The program can vary preferences or requirements of an employment opportunity based upon the characteristics of past employee performance.

The program can vary preferences of a candidate preference based upon the characteristics of past employment performance.

The program can also increase the compatibility verification ranking when an employment opportunity contains a preference for a certain characteristic but does not require that characteristic in a potential candidate, and the potential candidate demonstrates the certain characteristic.

The program can also vary a preference of an employment opportunity based upon normative data associated with selected characteristics correlated to that preference, such as the “soft skills” relating to the environment, culture, and aptitudes of the position demonstrated with the candidate profiles. Examples of the preferences that can be varied are the minimum and maximum skill level of a potential candidate. Such preferences are adjusted by a factor correlated to the percentage of the candidate's skill assessment based upon normative data. Another example of a preference that can be varied is the core sales skills desired in a potential candidate wherein said skills are, including but not limited to, demonstrating persuasive ability, communication skills, confidence in handling rejection, ability to be empathetic and relationship management.

The program can also rank the importance of selected preferences of the candidate, collect information about the rank the candidate assigns to each such preference, and adjust the compatibility verification by weighting comparisons to a preference by a factor correlating to the ranking of importance assigned to such preference.

For the candidate, the present invention offers a free, confidential, and hassle-free way to find a more compatible position. For the client, the present invention offers candidates that are vetted according to preferences and criteria specific to the necessities of a job requirement, creating a match with the highest probability of success and satisfaction in the job.

Experts estimate only 50% of sales hires succeed to reach quota. There is a long-felt need for many companies to find, screen, asses, and hire the most talented sales personnel. The present invention brings the power of machine learning, text analytics and pattern recognition to the problem of matching sales professionals with roles at companies. The present invention is a better method because it can capture more data with less effort. It is easier with no pesky profiles, no personality tests, and no sales evaluations. It is faster because there is no waiting for human resources to catalog resumes and background information, no lag time, and no bureaucracy. It is a smarter system and methodology because more data creates better algorithms and better algorithms facilitate better job matching. Overall, it is superior to current matching systems because the right person gets matched with the right role more frequently.

It is another object of the invention to provide a method of assisting candidates of finding careers appropriate for their skill set.

There is the potential for yet another object of the invention to provide a method for improving online dating services by using expanded profiles and bios to help dating partners determine compatibility.

### BRIEF DESCRIPTION OF THE DRAWINGS

The figures below depict various aspects and features of the present invention in accordance with the teachings herein.

FIG. 1 is a showcasing the various recruitment technologies and the evolution thereof exemplified by the methodologies summarized in the table.

FIG. 2 is diagram reflecting how the training data sets are integral to the assessment methodology taught by the present invention.

FIG. 3 is a flow chart of the steps an agent takes in identifying a candidate and matching the candidate to a suitable employment opportunity.

FIG. 4 is a flow chart of the steps an agent takes in gathering information about a candidate in order to create a profile that enables the matching of candidates to suitable employment opportunities shown in FIG. 3.

FIG. 5 is a summary diagram of process of the present invention.

### DESCRIPTION OF THE INVENTION

The present invention uses new data and new techniques based on science and data in a novel approach to finding, screening, and assessing sales candidates. The foundation of the system and method described herein is the belief that it is possible to use massive amounts of newly available data to better inform hiring decisions, particularly in the field of sales.

Traditional recruiting methods are not sufficient to match sales professionals. There are currently computerized job search systems and methods of posting job openings using a computer network. For instance, sales jobs are advertised on job boards such as Monster.com and TheLadders.com. These job boards and forms of recruiting potential employees rely on initiation by the candidate wherein they must submit their resume and find job opportunities based on keyword searching of its jobs databases. The next evolution of online-based job boards became job matching services such as Climber.com and Jobfox.com. These services create profiles of the potential employee candidates, employ semantic searches and provide a rudimentary analysis in the matching process. However, just like the earlier form of job boards and traditional recruiting, the potential employee candidates still have to initiate the process. The candidate being pro-active is still a requirement. This exemplifies why job boards and job matching are inefficient. The best candidates usually are not looking for a new position because they are too busy increasing sales, growing profitability, and improving efficiency for their current employer. These desirable “passive” candidates are often open to new opportunities, if they can be found. The reality is that since they are employed, it is unlikely they will be found in Internet (“online”) databases or on job boards. Top sales people are highly in demand and extra barriers are often in place so they usually don't switch jobs. As a result, top-tier talent does not answer ads or apply to web site postings.

By contrast, employers and job placement professionals are continuously hunting for top talent not just online, but through outreach and industry referrals. A great challenge that employers and job placement professionals encounter is accurately gauging a candidate's talents and aptitudes. This is primarily due to the fact that they mainly rely on databases of resumes and often times candidate profile assessments for keeping track of candidates.

Resumes only tell a portion of the candidate's story and cannot adequately reflect powers of persuasion and conversational prowess. Consequently, traditional hiring methods are not best for salespeople. Studies show over half of salespeople are poorly matched to their work environment. Traditional psychometric assessments have been around since the 1970's; however, they are inadequate. They can be time consuming, inconvenient, and have negative selection bias in the field of sales because they involve questionnaires or even proctored tests. The negative selection bias stems from the fact that top sales people are usually focused on talking and powers of persuasion, not concerned about filling out forms or taking proctored tests.

Posting a job and receiving applications and resumes in response exemplify the most traditional hiring method. Another example of a traditional hiring method is a job board. A job board is a centralized location where people looking for work might check every few days to see publicized offers of work. Job boards got their name from a physical board or case, often located in an employment center or agency, where job opportunities are posted but now job boards are commonly found on the Internet.

Job postings are often misleading and incomplete, meanwhile, job boards cannot search for candidates and analyze them the way that humans can. As a result, hiring decisions are often made on an intuitive or “gut instinct” and limited information. The data in a resume or a job posting is not sufficient to match a candidate to an opportunity. More data is needed to facilitate better matching.

Digitally-analyzed conversations can create better matches. A transcribed 45-minute phone call typically contains over 6,000 words which is tenfold more words than an average resume. With that much more data, a significantly better snapshot of the individual being profiled can be created. From that information, using linguistic technology to get a much better assessment of strengths and preferences is possible. Linguistic technology has already been used to predict human behavior in the fields of marriage counseling, medical malpractice, and homeland security.

The foregoing traditional recruitment systems are generally directed to a relatively early step in the employee search process, that is, the matching of the potential employee for a particular job. Because of this focus, significant limitations prevent such systems from being useful during other steps in the hiring process, particularly relating to assessing strength of skills or depth of experience. After all, not all sales positions require the same aptitudes.

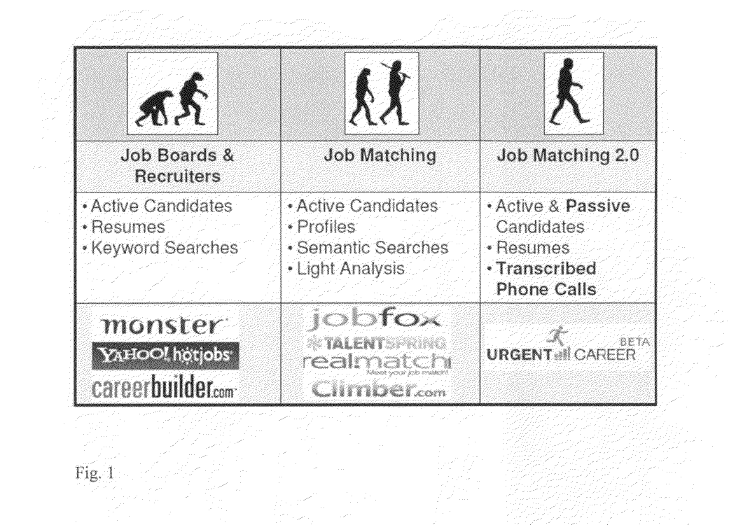

Automating an employment information exchange and providing a system and method of verifying employment compatibility goes where no job matching system or service has gone before. Potential employee candidates are no longer required to be pro-active in pursuing employment; they can now be passively involved. What's more, candidates no longer have to drive or command keyword and semantic searching for employment opportunities. Furthermore, data is collected and analyzed by a third party unbiased algorithm, thus eliminating the “human error” of both human “gut” assessments and candidate-answer based profile assessments. The right job opportunity can be discovered as easily as having a simple conversation. Refer to FIG. 1 to see the side-by-side comparison of the present invention against those of the previously established.

The invention will be described as it is embodied in a system used for automating an employment information exchange and providing a system and method of verifying employment compatibility using recorded telephone interviews. In the embodiment of the invention, the following comprise the elements of the invention.

An important element of the present invention is a means for collecting information about the relevant data for each candidate and job opportunity, which can be accomplished through an audible medium such as a telecommunications system connected to a telephone line through which the user data is collected using a telephone or voice recorder.

The user data is recorded by a computer and stored in the user's profile record in the profile database, which is another necessary element. While the invention may be implemented using a wide variety of computer systems, which may be programmed using a wide variety of existing programming languages and database programs, the software embodying the method is transportable to a variety of systems, such as personal computers, mainframes, a pager, a Internet- or Web-enabled phone, a personal digital assistant (PDA), a pen-based platform, a wireless digital platform, and a voice-based platform.

The next required element of the present invention, as more fully discussed below, is a means is a matching program which uses a series of procedures to match the user's profile record with a plurality of other compatible employment opportunity records in the database. A list of the acceptable matches made by the matching program can be stored in the user's profile record in the profile database.

Finally, a means of presenting to the user, as more fully described below, an aptitude or sales assessment report made by the matching program is an additional element of the present invention.

The process begins with educating the system by building the repository of job terms and keywords about the various positive, neutral and negative attributes of both the employment opportunities and job candidates. These attributes are compiled into what are referred to as data sets. These data sets are instrumental in the screening process because they serve as the building blocks of the screening criterion. After all, machine learning and pattern recognition are only as good as the data sets they work with.

Validation of data to be used for mapping and matching in the machine learning and pattern recognition process is essential; therefore training data sets are employed to properly validate accuracy and mediating mechanisms. One of skill in the art understands that linguistic analysis is dependent for their accuracy on the quality of the training data as much as on the algorithm employed. Assembling training sets of conversations can be performed using the following methods discussed below.

One of the important inputs for the system is the wisdom from very successful and experienced sales managers, their observations, and the language they use to describe great hires. Therefore, a method for collecting data to build data sets is to interview or survey experienced sales professionals with verifiable selling styles and performance to understand how they describe themselves, their experiences, and their skills. Experience sales professionals or expert individuals can also include veteran sales managers or individuals who have managed multiple sales divisions because this will also reveal a lot about attributes of successful sales people through the perspective of management. These individuals are typically non-candidate participants, but are not necessarily excluded from being potential candidates. Interviews can be conducted in person face-to-face or through an audible medium such as a call (examples of a call include a telephonic, computer, or audiovisual based call, collectively referred to as “call” hereafter). The live call occurring in real-time, the recording of the call, as well as the transcript of the interview or call can all then be dissected and mapped to the system's sales matching attributes to create semi-structured data sets. Machine learning technology then translates these data sets into algorithms trained to recognize these attributes in other candidate interviews.

A second method is expert-tagged candidate interviews wherein sample candidate interviews are analyzed and categorized by sales experts and psychologists according to the system's sales matching attributes. These conversations can be transcribed, recorded or live. Tagging is a practice of categorizing content using user-defined keywords. Tagging is known by a few different names, such as content tagging, collaborative tagging, social tagging and even the scientific-sounding “folksonomy.” In general tagging can be defined as the practice of creating and managing labels (or “tags”) that categorize content based on keywords. The benefit of using tags in the present invention is that information both about the opportunities or the candidates can be indexed based on specific keywords and concepts. The tagging should be performed by an expert in the field, but can also be performed by well-trained individuals. Tagging can be helpful, especially in cases in which the words might have multiple meanings, whereby tags can guide the algorithm of the search engine in choosing which of the several possible meanings for these words is correct. The conversations and tags are then used as a data set.

A third method is collecting feedback from purchasing experts wherein purchasing experts review interviews with candidates and provide feedback. The review of the interviews can be either reading a transcript or listening to the interview live or as a recording. The feedback can be provided through various means, including but not limited to, the use of a simple dial apparatus or voting mechanism that allows them to indicate positive or negative feedback or feedback that indicates a ranking of importance or priority. This feedback is used to score the candidates on the system's sales matching attributes and create semi-structured data sets.

A fourth method is third-party tests wherein sample candidates take part in a phone screening and take other third party assessment tests. The third party test results allow for the creation of tagged candidate interviews that are used directly as training set documents.

A fifth method is to include product and industry taxonomies as structured training set documents. These taxomonies will be used to identify specific product and industry experience in candidate interviews and/or to aid in manual tagging of candidate interviews. Said taxonomies are available from a variety of third party vendors and are easily integrated with any text analytics platform.

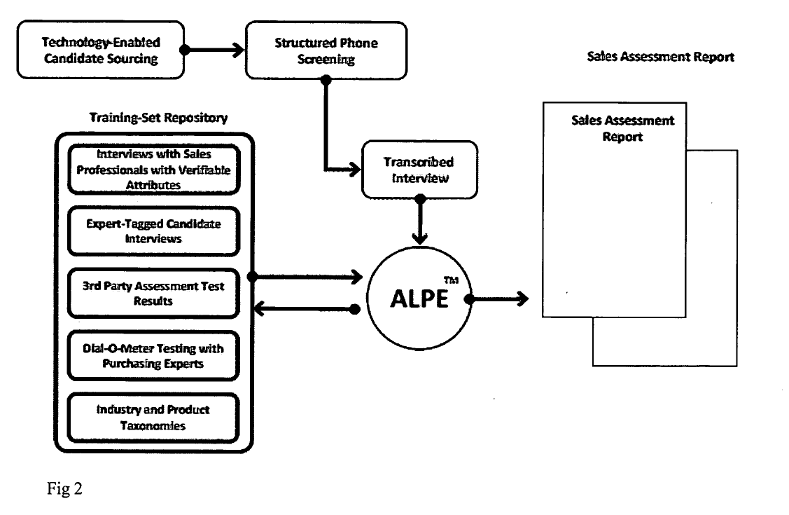

By using any of these approaches individually, or in combination, the system of the present invention is educated on the attributes of both the employment opportunities and job candidates as shown in FIG. 2. For useful, reliable results to be obtained, the training data set must be representative of the whole area to be analyzed—the spectrum of skills from strong skill sets to weak. This will create a continuum range which will later be instrumental in identifying strong from weak candidates. With each sales expert interview, the system gets smarter because the data can be mapped with better accuracy to correlating attributes or predefined classifications. Interviewing senior sales managers helps linguistically decompose the key attributes of a successful sales hire. The data sets are an important component to facilitating the linguistic analysis because their insights directly impact the algorithms and intelligence of the present invention.

At the core of the present invention's technology are powerful linguistic and statistical algorithms. Algorithm techniques used in the intelligence community, search engine and quantitative finance can be applied to interviews captured through voice calls, voice recordings as well as interview transcripts to better match sales people with the roles where they will be most likely to succeed. The use of linguistic and statistical profiling has proven successful in the quantitative finance, actuarial science, psychology, and professional sport recruiting fields. To our knowledge, the present invention is the first to apply this newly available technology to the problem of sales recruiting. The present invention's text analytic algorithms leverage statistical, vector, and linguistic approaches and aim to take into account many dimensions of sales success matching such as:

### Core Sales Traits

### Drive, Motivation, Discipline, and Goal Orientation

### Communication Skills

### Relationship Building

### Persuasiveness

### Rejection Handling

### Empathy

### Imp

Naïveté, Trust, and Skepticism

### Intellectual Curiosity

### Urgency

### Confidence

### Risk Taking

### Optimism

### Openness to Change (Flexibility)

### Sales Process Skills

### Pre-Prospecting Skills

### Prospecting/Qualifying Skills

### Pitching Skills

Closing/Negotiation skills
Service, support, up-selling skills

### Environment Compatibility Traits

Need for structure/autonomy
Team orientation
Attention to Detail/Organizational habits
Sales pace and cycle preference

### Problem Solving, Judgment, Ability to Learn

### Business Acumen

### Product-Specific Skills & Aptitudes

Product complexity
Value proposition type/complexity

### Product Experience

### Buyer Approach & Relationship Dynamics

### Industry Experience

### Occupational Experience

### Presentation Skills

Executive presence/rapport

### Channel Sales

The present invention involves large semi-structured text data sets combined with business and personality taxonomies to use pattern recognition, and machine learning to develop powerful algorithms. The algorithms allow Career Matchmakers to cluster, sort, filter and match candidates to positions where they are most likely to succeed. The field of technology is sometimes called Text Analytics or Natural Language Processing (NLP). Other technologies that are relevant to the scope of the present invention include, but are not limited to, Bayesian probability, Latent Semantic Analysis, Natural Language Processing, Pattern Recognition, Taxonomies, Text Analytics, and Text Clustering. It will be obvious to those of skill in the art how to create and implement such algorithms.

Building up a database of candidate profiles and realizing client companies in need of sales candidates can occur simultaneously. Furthermore, a method of two-way matching, by computing an index of compatibility based on both the desirability of the match from the point of view of the candidate and the desirability of the user from the point of view of the client company seeking potential candidates, can also serve to insure that only the most compatible matches are made between the client company and the sales candidate.

It will be readily understood by those skilled in the art that this method of automated information exchange and compatibility information is not limited to employment opportunities, but may be used to provide compatibility matching services using other access methods and in other fields. In the case of dating, developing data sets to educate the system would involve interviews of happy couples as well as the matched couples that proved to be incompatible.

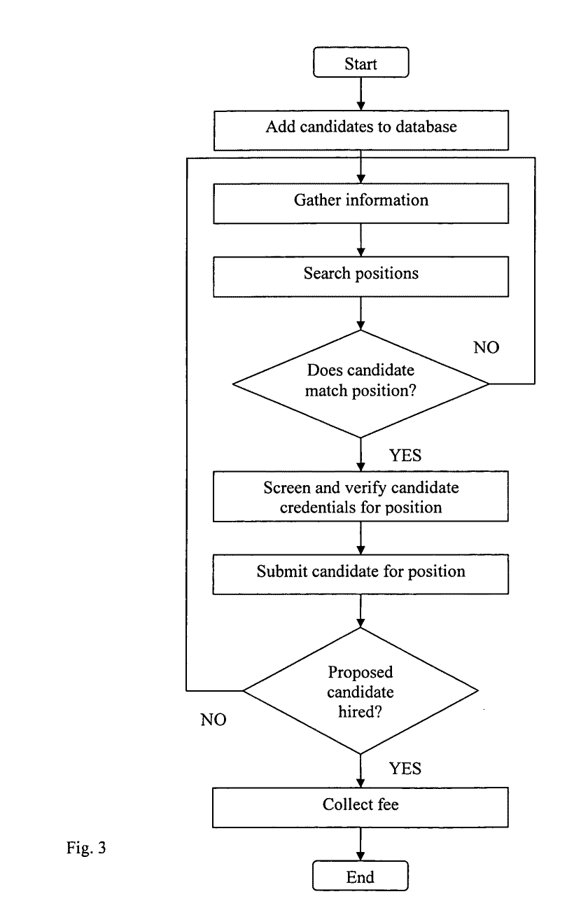

For the purposes of explaining an example of the present invention, the discussion begins with FIG. 3 depicting the screening process for a client company.

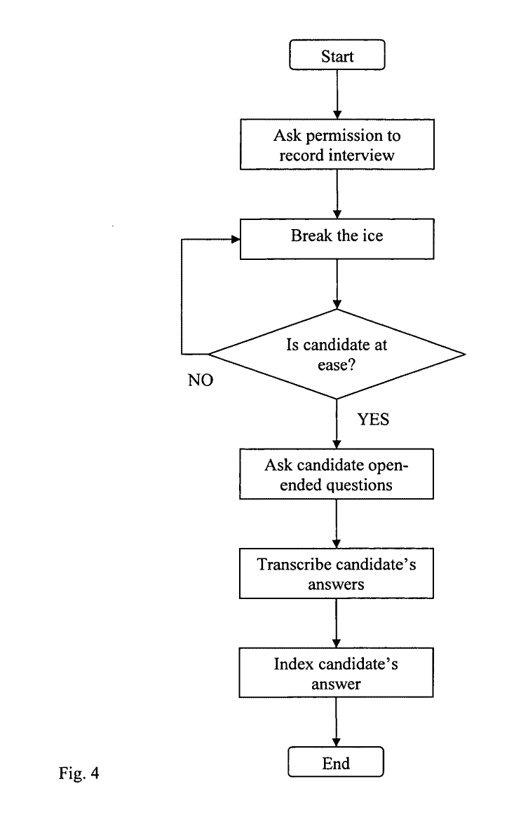

Referring to the drawing figures, FIG. 3 is a flow diagram of a system for facilitating the candidate screening process for a given company. After having candidate profiles in the database (said process depicted in FIG. 4), the next step is preparation. It is important to make sure the system has as much knowledge about the company, products, and industry the company is in thereby optimizing the training data sets as discussed previously. This knowledge or survey data can come from gathering data from available online material, industry articles and general internal knowledge repository. An interview is conducted with the Sales Manager to gain the best possible understanding of what the Sales Manager is looking for in the sales candidates (called a Requirements Gathering Session). In addition to interviewing a manager responsible for the hiring of a candidate, interviewing people who have been successful in the role or the people most familiar with the position can also be performed. The semi-structured interview is designed to ensure a thorough understanding of the company such as the company's organizational needs, products, selling process, culture, work day, incentive structure and job performance success criteria. The data collected from the survey interview can be used to determine a set of one or more factors associated with predicting satisfaction in a job or success in the role, including determining for each of the set of factors a corresponding function of one or more variables.

Interviews, whether in person or through calls, do not always need to be recorded. It is also possible to tag and analyze the calls in real-time or as a recording. However, a core part of the present invention's value proposition to the candidate is the method of linguistically analyzing the interview with the candidate. Therefore, it is preferred to record and transcribe the interview to further facilitate internal analysis and collaboration.

Using linguistic profiling, conversations can be algorithmically measured against objective position requirements. For example, conversations can be algorithmically measured against soft skill requirements that relate to the environment, culture, interpersonal skills, and aptitudes of the position. The linguistic matching technology of the present invention uses powerful algorithms based on natural language to deconstruct and measure conversations based on key dimensions of sales success.

The next step is to review the candidate profiles in the existing database and initiate outreach to candidates. An assessment of the data collected about each candidate is conducted to match attributes of the candidate that correspond with preferences and soft skill requirements of the employment opportunity to insure that only matches of the highest compatibility are made. The candidates can be assessed in a variety of ways, for instance, based on their skill sets, behaviors, attitudes, linking vocabulary to their domain of expertise, and measuring the extent of their industry knowledge based on keywords tagged in their interview transcript. There are many sales jobs that require an ability to speak with an appropriate technical vernacular; scoring a conversation based on the candidate's vocabulary in relation to industry can gauge the candidate's appropriateness for the position. This step in the process can include working with the Sales Manager to review the candidate profiles in order to confirm the understanding of the hiring position's requirements.

Step three involves a targeted outreach and candidate review. This step in the process can involve reaching out directly to potential candidates, as well as the communities and social networks that are statistically likely to be connected to the right candidates. It is preferred to reach out to candidates by telephone, personal email, and scientifically targeted advertising. Once contact has been made with the candidate and the candidate is open to the opportunity of being interviewed, dialogue with the candidate is engaged.

FIG. 4 conveys the process of building the database of candidate profiles. The telephone interview begins with asking for informed consent to record the interview. There are a multitude of vendors or off-the-shelf systems to enable telephone recording. The conversation should most likely proceed with easy or “soft ball” questions and dialogue to break the ice and get the candidate at ease. This will allow for the answers to be as natural as possible under the circumstance. The interviewers may not want to ignore or discount this in the analysis because this is strictly to get them in their normal comfort zone and out of the alarm of being “questioned.” Once the interviewer feels that the candidate is sufficiently as ease, the questions begin. It is best to use open-ended questions which give the candidate latitude to answer as naturally as possible. For example, with a sales oriented position you may want to ask questions around motivation and how he/she sets goals and/or how he/she persuades and communicates. Industrial psychologists and human resources experts will tell you that behavioral questions will yield the best results. It is preferred to ask questions that are based on past experiences and general disposition. Questions should be open-ended and specific, meanwhile addressing the past and the future, e.g. past behavior and future intentions/goals.

Retaining a record of the candidate's answers is a critical step to building the database of candidates. Transcribing the recorded interview is the means of retaining a record of the answers in addition to keeping the actual recorded interview. In the instance where the candidate does not allow the interview to be recorded, taking an accurate dictation of the answers is an alternative option. The transcription of the interview can occur in real-time or batch. It is preferred to do this in batch for simplicity; but there is no reason why it could not be done real-time. Important to note that better call equipment e.g. digital lines and quality microphones) will make transcription easier. To achieve the best clarity, record at highest resolution possible; using the best microphone possible typically provides the best resolution. It is also recommended to keep the recorded interview in case new algorithms and technology evolve (i.e. tonality approaches) can be applied later.

Once the transcription is completed or the answers of the interview have been logged into the database, the candidates profile then undergoes indexing or tagging as described previously. Indexing involves analyzing, organizing and scoring of the candidates answers based on the data sets from the experts, interviews and other verified inputs. The result is a profile generated that provides an accurate description of the candidate's skill set scored against the dimensions of sales compatibility. This profile, for example, can indicate that a candidate has very strong “prospecting” and “qualifying” skills, but has weak organizational and follow-up skills. This profiling technology is known as ALPE—Algorithmic-Linguistic Profiling Engine. ALPE is used to turn the transcribed phone conversation into a candidate's profile. The screening for a match of a candidate to a job opportunity is a process that can involve a variety of different approaches, examples including those such as cluster analysis, weighted criterion selection, keyword targeted searching as well as matching based on scored results. The various approaches can utilize the training set repository.

The success of the screening and matching process is largely dependent on an accurate understanding of the company's needs, sales process and target customer. Matchmakers can manually use candidate profiles to match job profiles, though this process may be automated in the future. Referring back to FIG. 1, the next stage of the process entails a comprehensive telephone screening of a select few candidates. A comprehensive phone interview with every candidate matched is scheduled and performed. The interview structure is designed to discover if the candidate has the potential to be a top performer. The type of sales environment that the candidate will thrive in is then assessed by leveraging the specialized understanding of the selling process, different work cultures, incentive structures and success criterions. The interview is summarized, then if the candidate is a strong fit the next step is to submit the candidate for consideration of the position. This is when interview scheduling, client screening and any jobs offers take place.

Interview scheduling is coordinated between the hiring company and the pre-screened job candidates. Some companies may like to have a set time each week where candidate interviews are scheduled; other companies keep calendar windows available for interviewing. The same is true for the job candidates. The important outcome is getting the appropriate flow of high potential candidates, giving the company the flexibility needed to build a strong sales team.

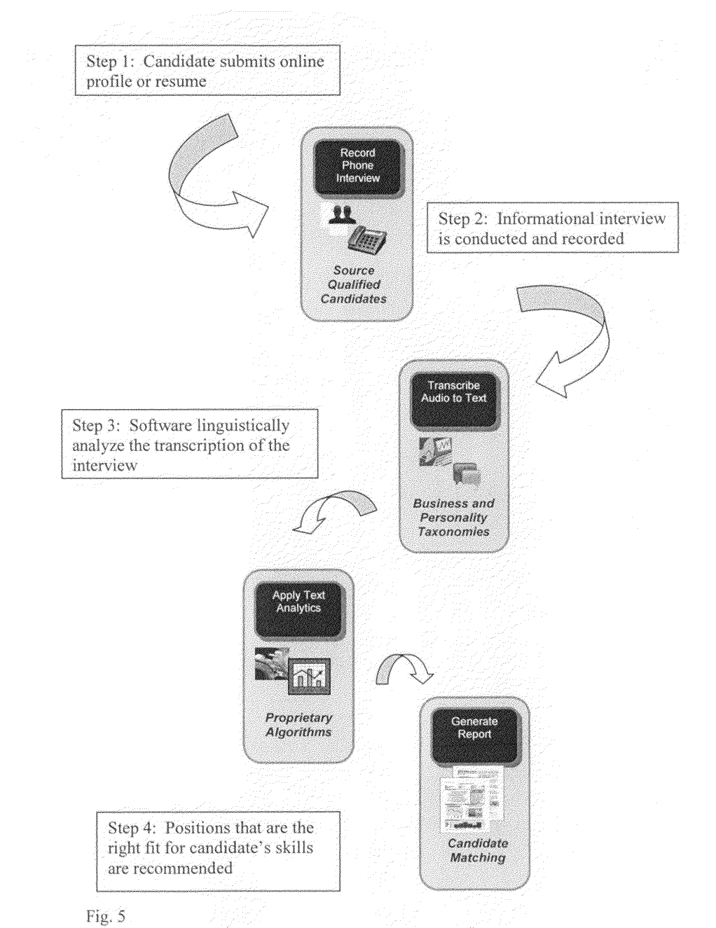

Understanding how the method according to the present invention works as the client-facing professional (a.k.a. the job candidates), is simple—just answer the questions asked during the interview and present invention system does the rest. FIG. 5 demonstrates the four easy steps that a job candidate would go through. The first step is to become identified as a candidate interested in being considered for job opportunities. This can occur in a number of ways as discussed earlier, as well as submitting a resume or online profile to the system.

The next step is to simply participate in the interview that allows the system to gather qualitative information about the candidate. The transcribed phone interview serves as the core text data used in our analysis. Then taxonomical information about industries, supply chains and sales environments is added to identify general and specific opportunities for the candidate. The matched positions that are the right fit for the candidate's unique skills are subsequently recommended to the candidate. In a preferred embodiment of the present invention, a fee is collected when an employer hires a job candidate recommended by or introduced by the Company. However, a fee can be collected for verifying employment compatibility in a variety of ways, including but not limited to, charging the employer for providing an introduction to compatible candidates, charging the employer to license the technology in its own recruiting efforts, charging the employer to evaluate its current salesforce or other communication-driven positions using the ALPE technology, charging the employer consulting fees to evaluate and subsequently hire new sales people, charging a third party to use the ALPE engine, charging the candidate a fee to receive his or her own profile after the call is completed, and more.

As already noted, the principles outlined in regard to the embodiment of the invention described in the text above can be applied to different sets of demographic/psychographic data. Those skilled in the art will understand the ready transferability of the invention's technology, applied in the employment compatibility and identification area, to such other matching applications.

The present invention has been described with respect to certain embodiments and conditions, which are not meant to and should not be construed to limit the invention. Those skilled in the art will understand that variations from the embodiments and conditions described herein may be made without departing from the invention as claimed in the appended claims.

### CONCLUSION

Having now described preferred embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto. Use of absolute terms, such as “will not,” “will,” “shall,” “shall not,” “must,” and “must not,” are not meant to limit the present invention as the embodiments disclosed herein are merely exemplary.

For example, the present invention may be implemented in hardware or software, or a combination of the two. Preferably, the present invention is implemented in one or more computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object-oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device. It will be appreciated that the system, method of operation and product may vary as to the details of its configuration and operation without departing from the basic concepts disclosed herein.

In the manner described above, the present invention thus provides a system, method, and program for screening people seeking employment with suitable job opportunities through the use of linguistic technologies. While this invention has been described with reference to the preferred embodiments, these are illustrative only and not limiting, having been presented by way of example. Other modifications will become apparent to those skilled in the art by study of the specification and drawings. It is thus intended that the following appended claims include such modifications as fall within the spirit and scope of the present invention.

What we claim is:

1. A method for using a computer processor to operate an automated employment information exchange, said method comprising:
collecting information about employment opportunities;
obtaining survey data from non-candidate survey participants, said survey data being responsive to inquiries into matters that are relevant to successful employees;
using said survey data to build a training set repository that will determine a set of one or more factors associated with predicting success in a job;
maintaining a database of candidates wherein information about each candidate is collected from an audible source;
applying a linguistic technology to convert the information about each candidate into a candidate profile that provides an accurate description of the candidate's skill set scored against the dimensions of sales compatibility;
comparing selected preferences in each employment opportunity with the information of each candidate profile in a database to eliminate incompatible profiles;
automatically identifying, based at least upon said set of factors in the training set repository, at least one of said candidates for an employment opportunity; and
reporting the compatible profiles.

2. The method of claim 1 wherein obtaining survey data to build training sets comprises extracting a first set of training data relating to interviewing sales professionals with verifiable attributes; extracting a second set of training data relating to expert-tagged candidate interviews; extracting a third set of training data relating to feedback from purchasing experts; extracting a fourth set of training data relating to third-party tests; and extracting a fifth set of training data relating to industry and products taxonomies.

3. The method of claim 1, further comprising the step of applying linguistic technologies to data collected from employment opportunity descriptions and data on candidate profiles to match suitable job opportunities with candidate profiles.

4. The method of claim 1, further comprising the steps of establishing a minimum threshold for the compatibility score and reporting only those matched profiles achieving the minimum threshold.

5. The method of claim 1, further comprising the step of varying a preference of a profile based upon the characteristics of past employment performance.

6. The method of claim 1, further comprising the step of adjusting the employment opportunity requirements based on the traits of past employees.

7. The method of claim 1, further comprising the step of increasing the compatibility verification ranking when an employment opportunity contains a preference for a certain characteristic but does not require that characteristic in a potential candidate, and the potential candidate demonstrates the certain characteristic.

8. The method of claim 1, further comprising the step of varying a preference of an employment opportunity based upon normative data associated with selected characteristics correlated to that preference.

9. The method of claim 7 wherein the preferences varied are the minimum and maximum skill level of a potential candidate and those preferences are adjusted by a factor correlated to the percentage of the candidate's skill assessment based upon normative data.

10. The method of claim 8 wherein the preference varied is the core sales skills desired in a potential candidate wherein said skills are selected from a group comprising persuasive ability, communication skills, confidence in handling rejection, ability to be empathetic and relationship management.

11. The method of claim 1, further comprising the steps of:
ranking the importance of selected preferences of the candidate;
collecting information about the rank the candidate assigns to each such preference;
adjusting the compatibility verification by weighting comparisons to a preference by a factor correlating to the ranking of importance assigned to such preference.

12. The method of claim 1 wherein the steps of collecting information are performed by recording the answers of candidate and non-candidate participants through semi-structured conversation.

13. The method of claim 11 wherein the data collected from the recorded answers is indexed for linguistic analysis.

14. A system to operate an automated employment information exchange comprising:
computer processor means for processing data;
first means for collecting information about the relevant characteristics for each candidate and non-candidate participant;
second means for collecting information about the preferences of each candidate and employment opportunity;
third means for comparing selected preferences in each candidate profile with characteristics of each employment opportunity in a database to eliminate incompatible profiles;
fourth means for verifying compatibility for each compared candidate profile and employment opportunity based on a comparison of selected preferences in each employment opportunity with the characteristics of each candidate profile to identify a plurality of compatible candidate profiles;
fifth means for sorting the compatible candidate profiles according to the verified compatibility; and
sixth means for reporting the candidate profiles and respective compatible employment opportunities.

15. The system of claim 13 further comprising a means for permitting the user to contact the potential matches through the system.

16. The system of claim 13 further comprising a means for collecting a fee.

17. The system of claim 13 wherein the means of collecting information about the preferences of each candidate and employment opportunity is through an audible medium.

18. The system of claim 13 wherein the means of verifying compatibility for each compared candidate profile and employment opportunity is a linguistic technology.

19. The system of claim 17 wherein a linguistic technology can be facilitated by programs selected from text analytics, algorithms, unbiased mathematics of machine learning, statistical analysis and pattern.

20. A computer based program for verifying compatibility of candidate profiles with employment opportunities through the use of linguistic technologies.
